(19) United States
(12) Patent Application Publication
(10) Pub. No.: US 2004/0019582 A1
(43) Pub. Date: Jan. 29, 2004

(54) Electronic interactive community directory and portable player unit

(76) Inventor: Merlyn Brown, Lawrence, KS (US)

Correspondence Address: THOMAS B. LUEBBERING, HOVEY WILLIAMS LLP, Suite 400, 2405 Grand, Kansas City, MO, 64108, US

(21) Appl. No.: 10/208,476

(22) Filed: Jul. 29, 2002

(51) Int. Cl. G06F 7/00

(52) U.S. Cl. 707/1

(57) ABSTRACT

An electronic interactive community directory (10) and portable player unit (12) adapted to receive, store, and provide for playback or otherwise communicate an information set (14) of information relating to people, businesses, or other members associated with a community of homes, businesses, or other interests, wherein the information is presented using a variety of media elements. The directory (10) includes a search function (38); a map and direction generator function (40); and network access (42) for accessing additional community-related information and functionality.

### BACKGROUND OF THE INVENTION

1. Field of the Invention

The present invention relates broadly to community directories and similar mechanisms for providing information regarding people and businesses associated with a community of homes, businesses, or other interests. More particularly, the present invention concerns an electronic interactive community directory and portable player unit adapted to receive, store, and provide for playback or otherwise communicate an information set of information relating to people, businesses, or other members associated with a community of homes, businesses, or other interests, wherein the information is presented using a variety of media elements, and the directory includes a search function, a map and direction generator function, and a network access function for accessing additional community-related information and functionality.

2. Description of the Prior Art

It is often desirable to access information regarding people, businesses, or other members of or otherwise associated with a community of homes, businesses, or other interests. Telephone directories and other prior art resources exist, for example, that provide such information for certain types of members of certain types of communities. Unfortunately, these prior art directories suffer from a number of problems and disadvantages that make them substantially unsuitable and impractical for many uses and contexts of use, including, for example, that they are limited with regard to their presentation of information, particularly the types of media that can be employed, being typically limited to a static content of text and still images and graphics. This limitation prevents conveying information using a more appropriate or effective media.

Furthermore, searching prior art directories for specific information, which typically involves guessing and tediously testing appropriate keywords, can be cumbersome and inefficient. Additionally, prior art directories offer no interactivity, particularly with regard to accessing electronic networks such as the Internet. This limitation prevents taking advantage of related functions and services available via such networks which could otherwise substantially supplement the functionality of the prior art directories. Relatedly, this lack of interactivity means that the prior art directories themselves cannot be conveniently supplemented, updated, or otherwise changed by the provider or by the user, such as, for example, with regard to business hours or directions. It will be appreciated that this can be a particular problem where a business moves or changes its telephone number a substantial time prior to the issuance of an updated directory. Additionally, advertising is limited to the same types of media used to present the information, with little or no ability to use other potentially more appropriate or effective types of media.

Another major disadvantage of prior art directories is that they can require enormous volumes of paper and other printing resources, and are correspondingly cumbersome and impractical to collect, store, transport, and access. The size and weight of prior art directories increases in direct relation to the size of the community serviced. Reducing font size is a well-known technique for reducing overall directory size, but this can be problematic for people with poor eyesight. Thus, particularly for larger communities where a user is most likely to need assistance in obtaining specific information about a member of the community, the directory becomes increasingly less efficient and practical to use. It will be appreciated, for example, that a traveler planning to travel through a number of large cities cannot practically collect and carry a copy of each city's prior art telephone directory. Similarly, a business person cannot practically collect, store, maintain, and manually search every relevant prior art product manufacturer directory. Additionally, when prior art directories become obsolete, they must be discarded or recycled, resulting in, respectively, substantial waste or increased cost.

Due to the aforementioned and other problems and disadvantages in the prior art, a need exists for an improved directory mechanism for providing community-specific information.

### SUMMARY OF THE INVENTION

The present invention overcomes the above-identified and other problems and disadvantages in the prior art by providing an electronic interactive community directory and portable player unit adapted to receive, store, and provide for playback or otherwise communicate information relating to people, businesses, or other members associated with a community of homes, businesses, or other interests, wherein the information is presented using a variety of media elements. The directory is independent of the nature of any particular community, and may relate to, for example, communities of people, homes, business, or other interests representing substantially any logical grouping of members. The directory is stored in digital electronic form on a suitable conventional electronic data storage or memory medium.

The directory broadly includes both an information set and a functionality set. The information of the information set may include a number of information subsets, such as, for example, a People subset; a Businesses subset; an Organizations subset; a Governmental Departments subset; an Attractions subset; a Miscellaneous subset; and an Emergency and Utility Contacts subset. A substantial advantage of the directory of the present invention over prior art directories is its ability to present the information of the information set and subsets using a variety of media elements, such as, for example, live and pre-recorded video, audio, still images and other graphics, animation, and text elements.

The People subset includes personal information about residents of the community, including, for example, names, interactive street addresses, interactive telephone numbers, interactive email addresses, and interactive personal website addresses. As appropriate, the information is conveniently editable by a user of the directory to update or otherwise correct the information. Depending on the directory's storage capacity, the People subset may include one or more website-style pages associated with certain individual persons or families, thereby allowing a user to access such enhanced information without requiring a network connection. Where appropriate, information of the People subset is interactive in that the information is selectable to result in some related function. Selecting a telephone address, for example, can initiate a telephone call via the player unit and a wireless communication network; selecting an email address can initiate an electronic mail session via the player unit, a remote host, and the wireless network; selecting a personal website address can initiate a network connection to a remote host via the player unit and the wireless network; and selecting a street address can cause to be displayed an electronic map, whether static or interactive, and may also cause to be generated corresponding textual directions.

The Businesses subset includes relevant information about businesses in the community; the Organizations subset includes relevant information about non-governmental organizations in the community; the Governmental Departments subset includes relevant information about governmental departments and organizations in the community; the Attractions subset includes relevant information about local, nearby, and regional attractions associated with the community; the Miscellaneous subset includes relevant information about any items of information which do not logically fall into one or more of the other subsets; the Emergency and Utility Contact subset includes contact information for those governmental departments or organizations associated with emergency assistance (e.g., police, fire, hospital) or with necessary public utilities (e.g., electric, gas, telephone, cable television). These subsets are all substantially similar to the People subset with regard to content, interactivity, and editability.

The listing of a specific item of information is not limited to any one subset, and may appear in multiple subsets wherever and whenever appropriate. Such redundancy, while not practical or possible in prior art directories, is an advantage in the present invention as it facilitates finding information without having to guess a single correct keyword or search term. Similarly, related information may be cross-referenced between subsets. Additionally, the directory may include various narrowly limited subsets of closely related information similar to the Emergency and Utility Contacts subset. These limited subsets facilitate finding important information quickly and more conveniently. Additionally, the user may be allowed to create such subsets, such as, for example, a Friends and Frequent Contacts subset, thereby allowing the directory to be used as an address book.

With regard to the functionality set, the directory includes features which facilitate more efficient use of the information set, including a search function; a map and directions generator function; and a network access function. The search function is a substantially conventional advanced search mechanism adapted to facilitate and assist a user in searching the directory. The map and directions function provides an electronic street map and may supplement the map by generating textual directions from a user-specified starting location to a user-specified destination, or may provide access and an interface to an Internet website providing these features. Any addresses appearing in the information may be linked directly to this function such that selecting an address causes a map of the area to appear. The network access function enables the user to access additional community information and useful functionality via a network such as the Internet.

Though the directory is accessible using substantially any conventional CD-ROM/DVD drive or player or other conventional device appropriate to the memory medium on which the directory is stored, the hand-held portable player unit may be used to conveniently retrieve and communicate the information stored in the directory. Such a unit, it will be appreciated, substantially enhances and facilitates use of the directory virtually anywhere, including, for example, while driving or walking through the community which is the subject of the directory.

In a preferred embodiment, the unit comprises a housing; a securement mechanism; a CD-ROM/DVD player; a display screen; an input mechanism; a detachable disk holder; an integral wireless communications device including a microphone, a keypad, and a speaker; a network port; and a power source. The securement mechanism is adapted to substantially secure the unit to a surface during use, and may take the form of a moldable “bean bag”-type mechanism wherein a relatively heavy and moldable material, such as metal shot, is encased in a flexible material, such as fabric, and coupled with the unit such that when the securement mechanism is placed upon a contoured surface the moldable material molds itself thereto in order to securely support the unit in a desired position. The detachable disk holder is adapted to receive and retain a plurality of the directories in close association with the unit for convenient access and use. The integral wireless communications device is adapted both to wirelessly facilitate a network connection needed to use some of the features, including any hyperlink elements, of the directory, and to allow for conventional wireless voice communication with another person. Such voice communication, it will be appreciated, facilitates use of the information, particularly with regard to telephoning the telephone numbers found in the directory.

Thus, it will be appreciated that the directory of the present invention provides a number of substantial advantages over prior art directories, including, for example, allowing for greater quantity and diversity of presentation of the information stored therein. Thus, whereas prior art directories were limited to a relatively small amount of text and a few small images, the directory is able to advantageously store or access and communicate detailed multimedia presentations combining a variety of media elements. Furthermore, whereas, with a prior art directory, searching for specific information typically involves inefficiently guessing and testing appropriate keywords, the directory advantageously provides one or more sophisticated search mechanisms that facilitate quicker, more convenient, more accurate, and more efficient searching. Additionally, whereas prior art directories offer no interactivity, particularly with regard to editing information or accessing electronic networks such as the Internet, the directory of the present invention advantageously provides such interactivity, thereby substantially enhancing the user's ability to update and otherwise edit and to research an item of information. Additionally, whereas in prior art directories advertising is limited to the same types of media used to present the information, the directory advantageously allows for the use of more sophisticated and effective types of media, thereby substantially enhancing the presentation and the user's experience. Additionally, whereas prior art directories can require enormous volumes of paper and other printing resources, and are correspondingly cumbersome and impractical to collect, store, transport, and access, the directory is advantageously compact, thereby allowing the user to carry the directory with him or her and to access and use it any time and any place. Additionally, the directory is accessible using any conventional computer-based CD-ROM drive, such as might be found, for example, in a commonly available desktop or portable computer. In order to enhance convenience of use and tradeability, however, the information stored in the directory can be retrieved and communicated using the portable player unit.

These and other important aspects of the present invention are more fully described in the section entitled DETAILED DESCRIPTION OF A PREFERRED EMBODIMENT, below.

### BRIEF DESCRIPTION OF THE DRAWINGS

A preferred embodiment of the present invention is described in detail below with reference to the attached drawing figures, wherein:

FIG. 1 is a block diagram of a preferred embodiment of the directory of the present invention showing possible content;

FIG. 2 is a first screen display of a preferred embodiment of a presentation of the content of the directory;

FIG. 3 is a second screen display of the preferred embodiment of the presentation of the content of the directory; and

FIG. 4 is a perspective view of a preferred embodiment of a portable player unit adapted to communicate and make use of the content of the directory.

### DETAILED DESCRIPTION OF A PREFERRED EMBODIMENT

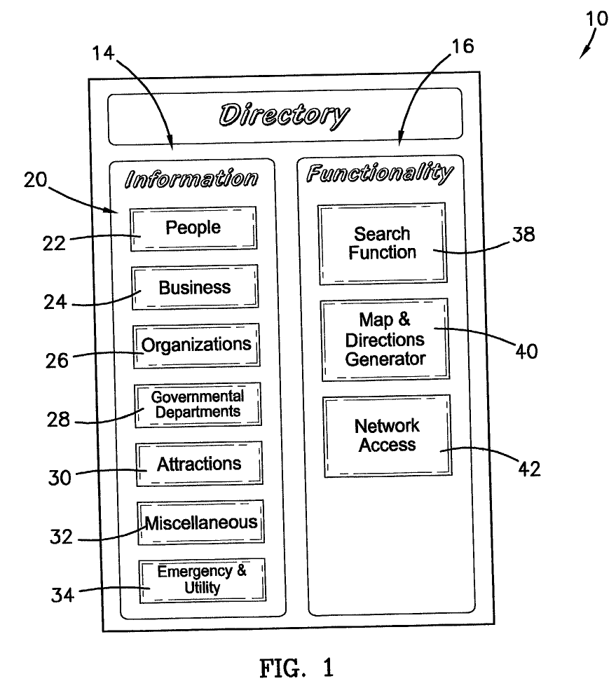

Referring to FIG. 1, an electronic interactive community directory 10 is shown constructed in accordance with a preferred embodiment of the present invention. The directory 10 is adapted to receive, store, and provide for playback or otherwise communicate information relating to people, businesses, or other members associated with a community of people, homes, businesses, or other interests, wherein the information is presented using a variety of media elements. Also shown is a portable player unit 12 which may be used to retrieve and communicate the information stored in the directory 10.

The directory 10 is preferably stored in digital electronic form on a suitable conventional electronic data storage or memory medium, such as, for example, a full-sized or miniature compact disk (CD), a full-sized or miniature digital video disk (DVD), or a memory stick. Where the directory 10 is stored on a miniature CD-ROM, for example, its capacity may be approximately 50 MB, which is sufficient to store between four and ten brief video movie clips, a number of audio clips, and a relatively large amount of text and still pictures, photographs, or other graphics. Furthermore, the information may be compressed using conventional compression techniques in order to maximize storage capacity. It will be appreciated, however, that future technological advances may provide alternative storage mediums or larger capacities, and that, therefore, the present invention should be considered independent of any particular storage medium or capacity.

The present invention is independent of the nature of any particular community, and may relate to, for example, communities of people, homes, business, or other interests representing substantially any logical grouping of members. Thus, the community could be based, for example, on a town or city or other geographic region; a university or college; a political party; a hobby, sport, or other social interest; or a particular area of business, including, for example, manufacturers or providers of certain products or services, such as hoteliers, grocers, musicians, attorneys, or doctors.

The directory 10 broadly includes both an information set 14 and a functionality set 16. It will be appreciated that the nature of the information provided by the directory 10 will depend to a great extent on the nature of the community and its members, but will generally include, for example, names (persons, businesses, or organizations), street addresses, electronic mail addresses, and website addresses. The information of the information set 14 may include a number of information subsets 20. Where the community is a town or city, for example, the information subsets may include a People subset 22; a Businesses subset 24; an Organizations subset 26; a Governmental Departments subset 28; an Attractions subset 30; a Miscellaneous subset 32; and an Emergency and Utility Contacts subset 34.

As mentioned, a substantial advantage of the directory 10 of the present invention over prior art directories is its ability to present the information using a variety of media elements, such as, for example, live and pre-recorded video, audio, still images and other graphics, animation, and text elements. It will be appreciated that the inclusion and contents of any particular media element will depend heavily on the nature of the subject community. Similarly, other appropriate media elements not specifically disclosed herein may be devised and included. The information set 14 and subsets 20 may incorporate any number and combination of these media elements in its presentation of information.

The People subset 22 includes personal information about residents of the community, including, for example, names, interactive street addresses, interactive telephone numbers, interactive email addresses, and interactive personal website addresses. As appropriate, the information is conveniently editable by a user of the directory 10 to update or otherwise correct the information. Depending on the directory's storage capacity, the People subset 22 may include one or more website-style pages for certain individual persons or families, thereby allowing a user to access such enhanced information without requiring a network connection. Where appropriate, information in the People subset 22 is interactive in that the information is selectable to result in some related function. Selecting a telephone address, for example, can initiate a telephone call via the player unit 12 and a wireless communication network; selecting an email address can initiate an electronic mail session via the player unit 12, a remote host, and the wireless network; selecting a personal website address can initiate a connection to a remote host via the player unit 12 and the wireless network; and selecting a street address can cause to be displayed an electronic map, whether static or interactive, and may also cause to be generated corresponding directions, as described below. Of course, at the discretion of the directory's creator, or in accordance with applicable law, persons may request that some or all of such personal information be excluded from the directory 10.

The Businesses subset 24 includes relevant information about businesses in the community, and is otherwise substantially similar to the People subset 22 with regard to information content, interactivity, and editability. Additional content may relate to more detailed information about the businesses, including, for example, hours of operation, history, staff/employees, and other locations.

The Organizations subset 26 includes relevant information about non-governmental organizations in the community, such as, for example, churches, private charities, animal welfare groups, support groups, hobby groups, or clubs, and is otherwise substantially similar to the People subset 22 with regard to information content, interactivity, and editability. Additional content may relate to more detailed information about the organizations, including mission statements (if applicable), service areas, and hours of operation.

The Governmental Departments subset 28 includes relevant information about governmental departments and organizations in the community, such as, for example, a division of motor vehicles, court houses, public utilities, public hospitals, and state run educational institutions, and is otherwise substantially similar to the People subset 22 with regard to information content, interactivity, and editability. Additional content may relate to more detailed information about the departments or organizations, including, for example, service areas and hours of operation. Those governmental departments or organizations associated with emergency assistance (e.g., police, fire, hospital) or with necessary public utilities (e.g., electric, gas, telephone, cable television) are also included in the Emergency and Utility Contact subset 34, described below.

The Attractions subset 30 includes relevant information about local, nearby, and regional attractions, such as, for example, natural parks and wonders, amusement and water parks, lakes and marinas, entertainment districts, art and other museums, and historical sites, and is otherwise substantially similar to the People subset 22 with regard to information content, interactivity, and editability. Additional content may relate to more detailed information about the attractions, including, for example hours of operation and ticket vendors.

The Miscellaneous subset 32 includes relevant information about any items of information which do not logically fall into one or more of the other subsets.

The Emergency and Utility Contact subset 34 includes contact information for those governmental departments or organizations associated with emergency assistance (e.g., police, fire, hospital) or with necessary public utilities (e.g., electric, gas, telephone, cable television). Additional content may relate to more detailed information about safety procedures and tips and, for utilities, hours of operation.

The listing of a specific item of information is not limited to any one subset 20, and may appear in multiple subsets 20 wherever and whenever appropriate. Such redundancy, while not practical or possible in prior art directories, is an advantage in the present invention as it facilitates finding information without having to guess a single correct keyword or search term. Certain organizations, for example, might provide both private and governmentally-contracted public services (e.g., hazardous waste removal/clean-up) and may, therefore, be listed in both the Organizations and the Governmental Department subsets 26,28. Similarly, it may be difficult for a user to know the private or public nature of a particular educational institution, so all such institutions may appear in both the Organizations and the Governmental Departments subsets 26,28. As desired, only the listing and not the information need be redundant, such that selecting a desired listing from any one of multiple subsets could hyperlink or otherwise send the user to a single information presentation.

Similarly, related information may be cross-referenced between subsets 20. Thus, the presentation of information for water parks and marinas, for example, found in the Attractions subset 30, might include a cross-reference to local businesses (found primarily in the Businesses subset 24) that provide relevant products and services, such as swimsuits or boat rentals.

Additionally, the directory 10 may include various narrowly limited subsets of closely related information similar to the Emergency and Utility Contacts subset 34. These limited subsets facilitate finding important information quickly and more conveniently, and the specific information may be repeated in appropriate broader information subsets. Furthermore, the user may be allowed to create such subsets, such as, for example, a Friends and Frequent contacts subset, thereby allowing the directory 10 to be used as an address book.

With regard to the functionality set 16, the directory 10 preferably includes features which facilitate more efficient use of the information set 14, including, for example, a search function 38; a map and directions generator function 40; and a network access function 42. The search function 38 is a substantially conventional advanced search mechanism adapted to facilitate and assist a user in searching the directory 10. Such assistance may take the form of, for example, automatically searching for words which are spelled or are phonetically similar or suggesting search terms which are logically related to the user-provided search terms. In addition or as an alternative to the aforementioned search mechanism, a top-down or general-to-specific search mechanism may be included wherein a user navigates the directory 10 in search of particular information by making increasingly specific selections within an information subset 20 which take the user to increasingly specific search screens until the particular desired information is found.

The map and directions function 40 provides an electronic street map and may supplement the map by generating textual directions from a user-specified starting location to a user-specified destination, or may provide access and an interface to an Internet website providing these features. Any addresses appearing in the information set 14 may be linked directly to this function such that selecting an address causes a map of the surrounding area to appear.

The network access function 42 enables the user to access additional community information and useful functionality via a network such as the Internet. Furthermore, such network access capability allows the directory creator to provide electronic updates to the directory via the network. Thus, for example, a user may be prompted when a periodic update is available for download via the network.

The directory 10, particularly the Businesses subset 24, may include a substantial advertising component. Such advertising provides a potential mechanism for generating substantial revenue for the creator and distributor of the directory 10, and may serve to offset the cost of producing and manufacturing the directory 10. Additionally, a certain amount of public service advertising may be made available to, for example, non-profit community welfare organizations of the Organizations subset 26, for little or no charge.

The advertising may take several forms, including, for example, a cursory text listing, without further detail; a hyperlink to a business' existing website; a thumbnail or banner add; or one or more full-page webpage-style presentations stored in the directory 10 and therefore available without a network connection. As mentioned, unlike prior art directories, whose presentation were limited to text and still images and graphics, the electronic nature, large storage capacity, and multi-media and hyperlinking capabilities of the present invention allow for incorporating a variety of media elements. This capability advantageously allows advertisers to customize and dynamicize their presentation to achieve the maximum desired effect. For example, a provider of boats or other watercraft may include video footage of various models in use; an art gallery may provide a slide show of work for sale; a dance club may provide live video of the dance floor via a conventional Internet camera; or a voice coach may provide appropriate audio accompaniment to his/her advertisement.

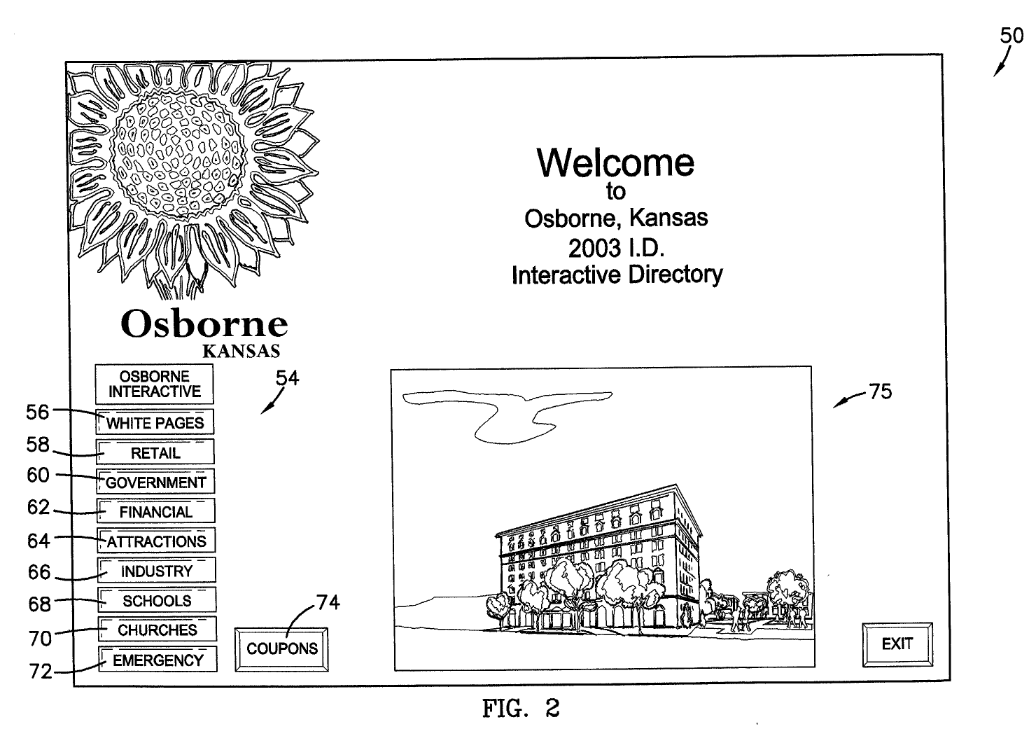

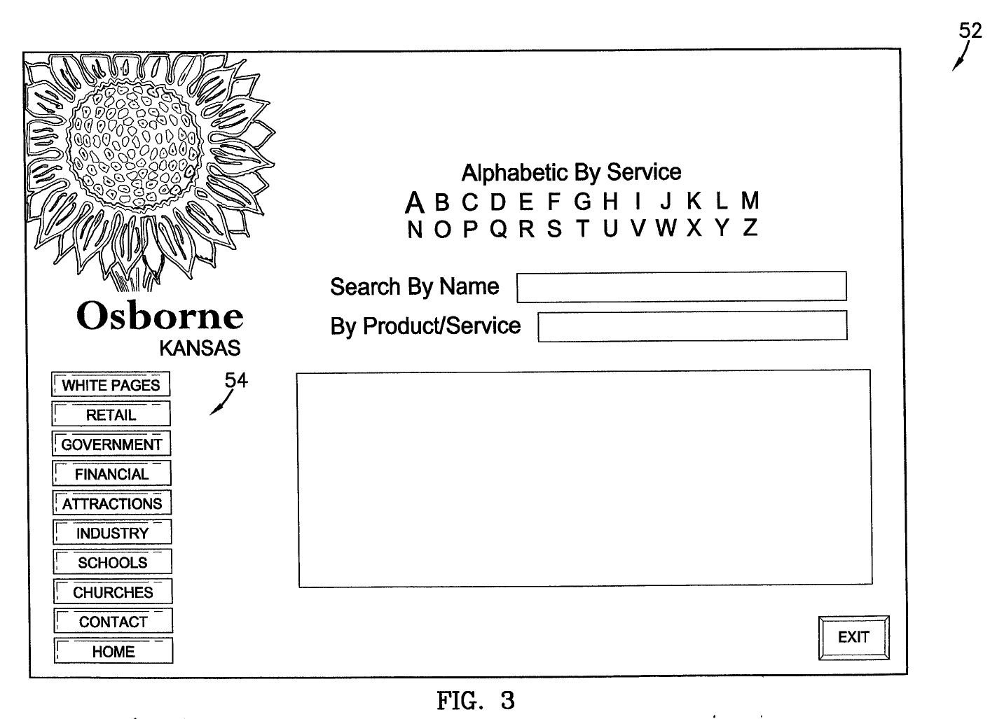

FIGS. 2 and 3 illustrate a portion of an exemplary presentation of the information of the information set 14 included in the directory 10. The presentation takes the form of a number of “pages”, including a Main or Home page 50 (FIG. 2) and a Search page 52 (FIG. 3). Other pages in this presentation are evidenced by a menu bar 54 of selectable links, including a White Pages link 56; a Retail link 58; a Government link 60; a Financial link 62; an Attractions link 64; an Industry link 66; a Schools link 68; a Churches link 70; an Emergency link 72; and a Coupons link 74. A number of these pages, it will be appreciated, correspond roughly to a number of the information subsets 20 discussed above; and each page may include any number or combination of the various media elements discussed above.

Referring to FIG. 2, the Home page 50 is the primary page to which the presentation defaults, particularly upon initial startup. As shown, The Home page 50 includes a still photograph, graphic, or other representation 74 of the community which is the subject of the directory 10. Alternatively or additionally, for example, the Home page 50 might include live streaming-video provided by a conventional Internet camera positioned within or overlooking the community. The Home page 50 also includes the menu bar 54 of selectable links to the other pages of the presentation.

Selection of the White Pages link 56, the Retail link 58, the Government link 60, the Attractions link 64, or the Emergency link 72 will cause to appear a corresponding presentation page setting forth and otherwise providing access to the information contained in, respectively, the People, Businesses, Government Departments, Attractions, and Emergency and Utility Contacts subsets 22,24,28,30,34, described above.

Selection of the Financial link 62 will cause to appear or otherwise provide access to an information subset of relevant information about local banking and other financial institutions and service providers. Selection of the Industry link 66 will cause to appear or otherwise provide access to an information subset of relevant information about local and regional commercial industry. Selection of the Schools link 68 will cause to appear or otherwise provide access to an information subset of relevant information about local private and public schools, including headstart, kindergarten, elementary schools, middle or junior high schools, high schools, community colleges, colleges, and universities. Selection of the Churches 70 will cause to appear or otherwise provide access to an information subset of relevant information about local churches and houses of worship. These subsets are otherwise substantially similar to the People subset 22 with regard to information content, interactivity, and editability.

Selection of the Coupons link 74 will cause to appear or otherwise provide access to printable coupons provided or authorized by various members of the community, such as, for example, various businesses found in the Businesses subset 24. The coupons may be printed by the user as needed and used in the community.

Referring to FIG. 3, the Search page 52 is shown adapted to allow the user to search for and find a specific item of information in the directory 10. As mentioned, a number of different search mechanisms may be used. As shown, two different search mechanisms are available to the user. The first search mechanism allows the user to select a letter associated with the desired item of information. Such selection causes to appear a listing of all directory entries starting with the selected letter. The second search mechanism allows the user to enter either a name or a product/service term. The search engine will then search the directory and return all entries matching the entered name or terms. It will be appreciated, however, that substantially any search mechanism or combination therefore can be used.

The directory 10 is preferably stored, when not in use, in a paper or plastic sleeve. The sleeve may present one or more graphics and text related to the community for easier identification by the user.

It is anticipated that the directories 10 may be sold individually or in sets. Such sets may take the form of a logical grouping of related communities, such as for example, the two or more suburbs of a major metropolitan area.

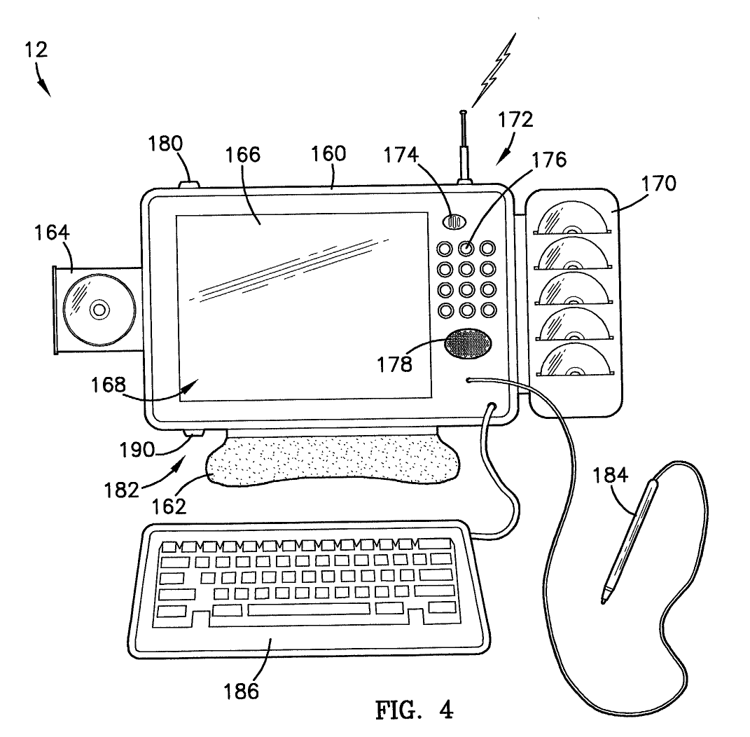

Referring to FIG. 4, as mentioned, the directory 10 is accessible using substantially any conventional CD-ROM/DVD drive or player or other conventional device appropriate to the memory medium on which the directory 10 is stored, such as might be found, for example, in a commonly available desktop or portable computer or in a commonly available standalone CD-ROM/DVD player. Alternatively, in the interests of convenience and portability the hand-held portable player unit 12 may be used to retrieve and communicate the information stored on the directory 10. Such a unit 12 substantially enhances use of the directory 10 virtually anywhere, including, for example, while driving or walking through the community which is the subject of the directory 10.

In a preferred embodiment, the unit 12 comprises a housing 60; a securement mechanism 62; a CD-ROM/DVD player 64; a display screen 66; an input mechanism 68; a detachable disk holder 70; an integral wireless communications device 72 including a microphone 74, a keypad 76, and a speaker 78; a network port 80; and a power source 82.

The housing 60 is adapted to protectively house and enclose other components of the unit 12. As such, the housing 60 is preferably constructed of a lightweight impact-resistant material, such as, for example, plastic or carbon fiber. The housing 60 may include an integral carrying handle to further enhance the unit's portability.

The securement mechanism 62 is adapted to substantially secure the unit 12 to a surface during use. The securement mechanism 62 may take any appropriate form, including, for example, a weighted base or a hook-and-loop arrangement. The securement mechanism 62 may also take the form of a moldable “bean bag”-type mechanism wherein a relatively heavy and moldable material, such as metal shot, is encased in a flexible material, such as fabric, and coupled with the unit such that when the securement mechanism 62 is placed upon a contoured surface the moldable material molds itself thereto in order to securely support the unit in a desired position.

The CD-ROM/DVD player 64 is operable to receive the directory 10, to retrieve the information stored thereon, and to provide the retrieved information to the display screen and the speaker for presentation. The CD-ROM/DVD player 64 may be any substantially conventional and commonly available drive or player which, due to space and portability considerations, is preferably limited to receiving and playing only miniature CD-ROMs or DVDs and not the full-sized embodiments thereof.

The display screen 66 is substantially conventionally adapted to visually communicate the presentation of the information retrieved and provided by the CD-ROM/DVD player 64.

The input mechanism 68 is operable to provide input related to controlling, navigating, and editing the presentation of the information. Thus, the input mechanism 68 may be any substantially conventional input mechanism, such as, for example, a touch screen mechanism having an optional stylus 84, and a detachable alphanumeric keyboard 86 for entering text, such as when editing the information or entering search terms. The keyboard 86 is detachable so as to enhance the unit's portability. Additionally or alternatively, the unit 12 may include a conventional touch pad or trackball operable to position and otherwise control a virtual pointer appearing on the display screen, and to input a user selection.

The detachable disk holder 70 is adapted to receive and retain a plurality of the directories 10 in close association with the unit 12 for convenient access and use. The disk holder 70 is detachable to enhance the unit's portability.

The integral wireless communications device 72 is adapted both to wirelessly facilitate a network connection needed to use some of the features, including the hyperlink elements, of the directory 10, and to allow for conventional wireless voice communication. Such voice communication, it will be appreciated, facilitates use of the information, particularly with regard to telephoning the telephone numbers found in the directory 10. The microphone 74, keypad 76, and speaker 78 facilitate, in substantially conventional manners, such use of the integral wireless communications device. The speaker 78 is also conventionally adapted to audibly communicate the presentation of the information retrieved and provided by the CD-ROM/DVD player 64.

The network port 80 provides a connection point for connecting the unit 12 to a network, such as, for example, the Internet. The network port 80 provides an alternative to the wireless network connection allowed for by the integral wireless communication device 72 described above. Such a network connection is not generally necessary for using the unit 12, but is necessary to use any Internet-accessible or other network accessible hyperlinks or other information or functions which may be included in the presentation.

The power source 82 is adapted to power the unit 12. Preferably, the unit 12 includes both an internal rechargeable battery (not shown) and a power port 90 adapted for connecting the unit 12 to either a 110 VAC wall outlet or a 12 VDC vehicle outlet to supplement the battery.

In exemplary use and operation, the user of the directory 10 and player unit 12, planning a trip to a city to which he or she plans to subsequently move, obtains (e.g., orders via the Internet) a directory 10 of the city itself and a directory 10 of a nearby town. Prior to leaving, the user selects the White Pages link 56 and searches for a friend who now lives in the city. Once the friend's listing is found, the user finds in the directory 10 a link to the friend's family website and is able to connect to the Internet, using the network access functionality 42 of the directory 12 and the network port 80 of the unit 12, to view the website. Furthermore, from the friend's listing, the user is able to select the interactive telephone number to initiate a telephone call, using the integral wireless communication device 72 of the unit 12, to arrange to meet the friend. Additionally, though provided with directions to the friend's house, the user is able to select the interactive street address from the friend's listing to create, using the map and directions generator functionality 40 of the directory 10, a printable map and to generate printable directions.

The user then selects the Retail and Industry links 58,66 and browses these subsets to get a feel for the city's various businesses and industry. The user identifies potential lodging and selects a hyperlink to the hotel's Internet website where the user is able to arrange reservations. The user then selects the Attractions link 64 and browses the directory 10 for city attractions that might be interesting.

Driving to the city, the user keeps the unit 12 close at hand just in case the user needs directions while driving.

While walking through the city, the user selects the Business link 58 to find restaurants and department stores, and uses the map and directions functionality 40 to find various places of interest. Though this would not have been practical with prior art directories because of their size and weight, it is possible with the lightweight directory 10 and portable player unit 12 of the present invention.

While driving, the user sees a stalled vehicle and a stranded motorist who appears to need assistance. The user selects the Emergency 72 link to find a telephone number to the local Motorist Assist. The user selects the identified interactive telephone number to initiate a telephone call via the unit 12, and uses the speaker 78 and microphone 74 for hands-free communication to report the stranded motorist.

One month later, the friend moves to a different apartment within the city. The user conveniently edits the friend's listing in the directory 10 to reflect the friend's new address and telephone number.

From the preceding description, it will be appreciated that the directory 10 of the present invention provides a number of substantial advantages over prior art directories, including, for example, allowing for greater quantity and diversity of presentation of the information stored therein. Thus, whereas prior art directories were limited to a relatively small amount of text and a few small images, the directory 10 is able to advantageously store or access detailed multimedia presentations combining a variety of media elements. Furthermore, whereas with a prior art directory searching for specific information typically involve inefficiently guessing and testing appropriate keywords, the directory 10 advantageously provides one or more sophisticated search mechanisms that facilitate quicker, more convenient, more accurate, and more efficient searching. Additionally, whereas prior art directories offer no interactivity, particularly with regard to editing information or accessing electronic networks such as the Internet, the directory 10 advantageously provides such interactivity, thereby substantially enhancing the user's ability to update and otherwise edit or research an item of information. Additionally, whereas in prior art directories advertising is limited to the same types of media used to present the information, the directory advantageously allows for the use of more sophisticated and effective types of media, thereby substantially enhancing the presentation and the user's experience. Additionally, whereas prior art directories can require enormous volumes of paper and other printing resources, and are correspondingly cumbersome and impractical to collect, store, transport, and access, the directory 10 is advantageously compact, thereby allowing the user to carry the directory with him or her and to access and use it any time and any place. Additionally, the directory 10 is accessible using any conventional computer-based CD-ROM drive, such as might be found, for example, in a commonly available desktop or portable computer. In order to enhance convenience of use and tradeability, however, the information stored in the directory can be retrieved and communicated using the portable player unit 12.

Although the invention has been described with reference to the preferred embodiment illustrated in the attached drawings, it is noted that equivalents may be employed and substitutions made without departing from the scope of the invention as recited in the claims. Thus, for example, though described herein as being based upon an electronic date storage medium in the form of a CD-ROM or DVD nature, the directory 10 may utilize substantially any suitable electronic data storage medium. Furthermore, the directory 10 is substantially independent of the nature of the community. Relatedly, the inclusion and contents of any particular information subset will depend heavily on the nature of the community and are therefore not limited to those described herein for illustrative purposes only.

Having thus described the preferred embodiment of the invention, what is claimed as new and desired to be protected by Letters Patent includes the following:

1. An electronic community directory comprising:
a storage medium;
an information set of information stored on the storage medium in a retrievable form, wherein the information is related to a community and includes a plurality of names, addresses, and telephone numbers of members of the community; and
a functionality set of functions stored on the storage medium in a selectable form, wherein the functions relate to using the information and include
a search function adapted to facilitate searching the information of the information set,
a map function adapted to provide an electronic map showing the plurality of addresses, and
a network access function adapted to connect the electronic community directory to a network wherefrom additional information relating to the community is available.

2. The electronic community directory as set forth in claim 1, wherein at least a portion of the information is presented using a video movie element, an audio element, a still element, a text element, and a hyperlink element providing a selectable electronic link via the network access function to an external source of information.

3. The electronic community directory as set forth in claim 1, wherein the information set includes a
people subset of information relating to people associated with the community;
a businesses subset of information relating to businesses associated with the community;
an organizations subset of information relating to organizations associated with the community;
a governmental departments subset of information relating to governmental departments associated with the community;
an attractions subset of information relating to attractions associated with the community; and
an emergency contacts subset of information relating to emergency services contact information for the community.

4. The electronic community directory as set forth in claim 1, wherein at least some of the information is stored on the storage medium in a compressed state.

5. The electronic community directory as set forth in claim 1, wherein the information set includes at least one advertising element.

6. An electronic community directory comprising: a storage medium;
an information set of information stored on the storage medium in a retrievable form, wherein the information is related to a community and includes a
people subset of information relating to people associated with the community,
a businesses subset of information relating to businesses associated with the community,
an organizations subset of information relating to organizations associated with the community,
a governmental departments subset of information relating to governmental departments associated with the community;
an attractions subset of information relating to attractions associated with the community,
an emergency contacts subset of information relating to emergency services contact information for the community; and
a functionality set of functions stored on the storage medium in a selectable form, wherein the functions relate to using the information and include
a search function adapted to facilitate searching the information of the information set,
a map function adapted to provide an electronic map showing the plurality of addresses, and
a network access function adapted to connect the electronic community directory to a network wherefrom additional information is available.

7. The electronic community directory as set forth in claim 6, wherein at least a portion of the information is presented using a video movie element, an audio element, a still element, a text element, and a hyperlink element providing a selectable electronic link via the network access function to an external source of information.

8. The electronic community directory as set forth in claim 6, wherein at least some of the information of the information set is stored on the storage medium in a compressed state.

9. The electronic community directory as set forth in claim 6, wherein the information set includes at least one advertising element.

10. An electronic community directory system comprising:
a storage medium;
an information set of information stored on the storage medium in a retrievable form, wherein the information is related to a community and includes a plurality of names, addresses, and telephone numbers of members of the community;
a functionality set of functions stored on the storage medium in a selectable form, wherein the functions relate to using the information and include
a search function adapted to facilitate searching the information of the information set,
a map function adapted to provide an electronic map showing the plurality of addresses, and
a network access function adapted to connect the electronic community directory to a network wherefrom additional information relating to the community is available; and
a player unit adapted to retrieve and communicate the information set from the storage medium, wherein the player unit includes a
hand-held portable housing,
a player adapted to removably receive the storage medium,
a display screen and speaker adapted to visually and audibly communicate the information stored on the removably received storage medium,
an input mechanism adapted to allow a user to navigate the information communicated by the display screen and the speaker,
a wireless communication device adapted to allow for wireless voice and data communication, and
a network port adapted to selectively connect the player unit to a network wherefrom additional information relating to the community is available.

11. The electronic community directory as set forth in claim 10, wherein at least a portion of the information is presented using a video movie element, an audio element, a still element, a text element, and a hyperlink element providing a selectable electronic link via the network access function to an external source of information.

12. The electronic community directory as set forth in claim 10, wherein the information set includes
a people subset of information relating to people associated with the community;
a businesses subset of information relating to businesses associated with the community;
an organizations subset of information relating to organizations associated with the community;
a governmental departments subset of information relating to governmental departments associated with the community;
an attractions subset of information relating to attractions associated with the community; and
an emergency contacts subset of information relating to emergency services contact information for the community.

13. The electronic community directory as set forth in claim 10, wherein at least some of the information of the information set is stored on the storage medium in a compressed state.

14. The electronic community directory as set forth in claim 10, wherein the information set includes at least one advertising element.

15. The electronic community directory as set forth in claim 10, wherein the player is a CD-ROM/DVD player.

16. The electronic community directory as set forth in claim 10, wherein the input mechanism includes a detachable alphanumeric keyboard.

17. The electronic community directory as set forth in claim 10, wherein the wireless communication device is adapted to provide a wireless network connection for connecting the player unit to a network wherefrom additional information relating to the community is available.

18. The electronic community directory as set forth in claim 10, further including a disk holder detachably coupled with the housing and adapted to receive and retain the storage medium.

19. The electronic community directory as set forth in claim 10, wherein the player unit further includes a securement mechanism for supporting the player unit during use, the securement mechanism including a moldable material encased in a flexible material and coupled with the player unit such that the securement mechanism is physically adaptable to support the player unit upon a contoured surface.
